(19) United States
(12) Patent Application Publication
(10) Pub. No.: US 2014/0361134 A1
(43) Pub. Date: Dec. 11, 2014

(54) SUSPENDING ARM COMBINED TO SCREEN SUPPORTING FRAME

(71) Applicant: MIN-LON CHUANG, Taipei County (TW)

(72) Inventor: MIN-LON CHUANG, Taipei County (TW)

(21) Appl. No.: 13/913,518

(22) Filed: Jun. 10, 2013

(51) Int. Cl. F16M 13/00

(52) U.S. Cl. CPC F16M 13/00
USPC 248/276.1

(57) ABSTRACT

A suspending arm combined to a screen supporting frame comprises an upper supporting arm; a lower supporting arm; a supporting seat joint having a first adaptor unit and a first pivot unit; the first pivot unit being pivoted to the upper supporting arm and lower supporting arm; a screen joint including a second adaptor unit and a second pivot unit; the second pivot unit being pivoted to the upper supporting arm and lower supporting arm; one end of the connecting block being pivoted into the screen joint; an air pressure; one end of an air pressure bar being pivoted to the lower supporting arm and another end of air pressure bar being pivoted to the connecting block; a fine adjusting unit including a screw and a positioning block; the screw passing through the positioning block and being then screwed to the connecting block.

The application is a continuation in part (CIP) of U.S. Pat. No. 11/756,614 assigned to the applicant of the present invention. Therefore, the contents of the invention is incorporated into the present invention as a part of the present invention.

### FIELD OF THE INVENTION

The present invention relates to suspending arms, and particularly to a suspending arm combined to a screen supporting frame, wherein a height and orientation thereof can be adjusted freely.

### BACKGROUND OF THE INVENTION

Due to the rapid progress in technology, the volume of a display have become smaller and smaller. For example, the volume of a liquid crystal display is far smaller than that of a convention cathode ray tube display. Thereby it is lighter than the prior art one.

Furthermore, most of displays have a seat for supporting the display on a table surface. One way for fixing the display is to fix the display to a wall. However above mentioned two prior art ways can not make the display rotatable. Thus in one improvement, the display is retained to a support frame having a suspending arm so that the orientation and aspect of the display is changeable. Thus, the space required is saved. However this improvement way still has one problem that if displays of different weights are suspended by the suspending arm, the user must adjust the display and the suspending arm to be positioned at a preferred position and aspect. However the mechanism for adjusting is hidden in some place which is not easy to be approached. Thus the operation is inconvenient and difficult.

### SUMMARY OF THE INVENTION

Accordingly, the primary object of the present invention is to provide a suspending arm combined to a screen supporting frame, wherein a height and orientation thereof can be adjusted freely.

To achieve above objects, the present invention provides a suspending structure, in that a supporting frame of a suspending arm is combined to a supporting seat and a screen supporting seat so that the user can adjust an elevation and position of a screen. The present invention has the following elements.

An upper supporting arm is included.

A lower supporting arm is included.

A supporting seat joint has a first adaptor unit and a first pivot unit. The first pivot unit is pivoted to the upper supporting arm and lower supporting arm so that the upper supporting arm and lower supporting arm are pivoted to the supporting seat joint.

A screen joint includes a second adaptor unit and a second pivot unit. The second pivot unit is pivoted to the upper supporting arm and lower supporting arm so that the upper supporting arm and lower supporting arm is pivotally rotatable with respect to the screen joint. One end of the connecting block is pivoted into the screen joint.

An air pressure bar is included. One end of an air pressure bar is pivoted to the lower supporting arm and another end of air pressure bar is pivoted to the connecting block.

A fine adjusting unit includes a screw and a positioning block. The screw passes through the positioning block and is then screwed to the connecting block. The positioning block is connected to the screen joint. When the screw rotates, the connecting block is pushed or pulled. By adjusting the screw, the relative positions of the positioning block and the connecting block are changed. The screw is a manual adjust screw so that the user can operate it without needing any tool. By the fine adjusting unit to adjust the position of the connecting block, a length of the air pressure bar is adjustable so that the supporting force released from the air pressure bar is changed without using any other locking way so that the orientation of the structure of the present invention is retained. Each of the supporting seat joint and the screen joint has a respective combining groove, respectively.

The upper supporting arm includes a top sheet and two lateral sheets. The lower supporting arm includes a bottom sheet and two lateral sheets. After assembly, they are used to mask the air pressure bar and other elements therein so as to protect theses elements. Moreover, each of the two lateral sheets is connected to a cover for covering the pivotal holes of the upper supporting arm to present a beautiful outlook.

A shaft serves to pivot the air pressure bar and the connecting block at the same point. Further, a threaded block is installed in the connecting block. The threaded block has a screw hole for receiving the screw. When the screw is rotated, the threaded block will be driven to rotate. By the threaded block to push the connecting block, the position of the connecting block is changed. One end of the connecting block is pivoted to the screen joint and thus the connecting block will rotate along a pivoted point. When the rotate angle of the connecting block is changed, the length of the air pressure bar pivoted thereto is also changed so as to adjust the supporting force.

A distance AB between the pivotal point A of the upper supporting arm to the adjusting unit and the pivotal point B of the supporting seat joint and the upper supporting arm is equal to a distance CD between the pivotal point C of the lower supporting arm and the screen joint and the pivotal point D of the lower supporting arm and the supporting seat joint. Furthermore the distance AC is also equal to the distance BD so that the pivotal points A, B, C and D is formed as a parallelogram. Thus if the orientation of the air pressure bar is adjusted, the screen joint is also adjusted.

The pivotal points A, B, C and D are retained with a predetermined relation and thus the screen joint is retained in a fixed direction. The length of the air pressure bar is also changed.

The various objects and advantages of the present invention will be more readily understood from the following detailed description when read in conjunction with the appended drawing.

### BRIEF DESCRIPTION OF THE DRAWINGS

FIG. 1 shows the application of the present invention.

FIG. 2 shows the perspective view of the present invention.

FIG. 3 shows the exploded view of the present invention.

FIG. 4 shows the cross section view of the present invention.

FIG. 5 shows the cross section view about the application of the present invention.

FIG. 6 is a structural cross section view of the present invention.

FIGS. 7 to 16 are schematic views about the application of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

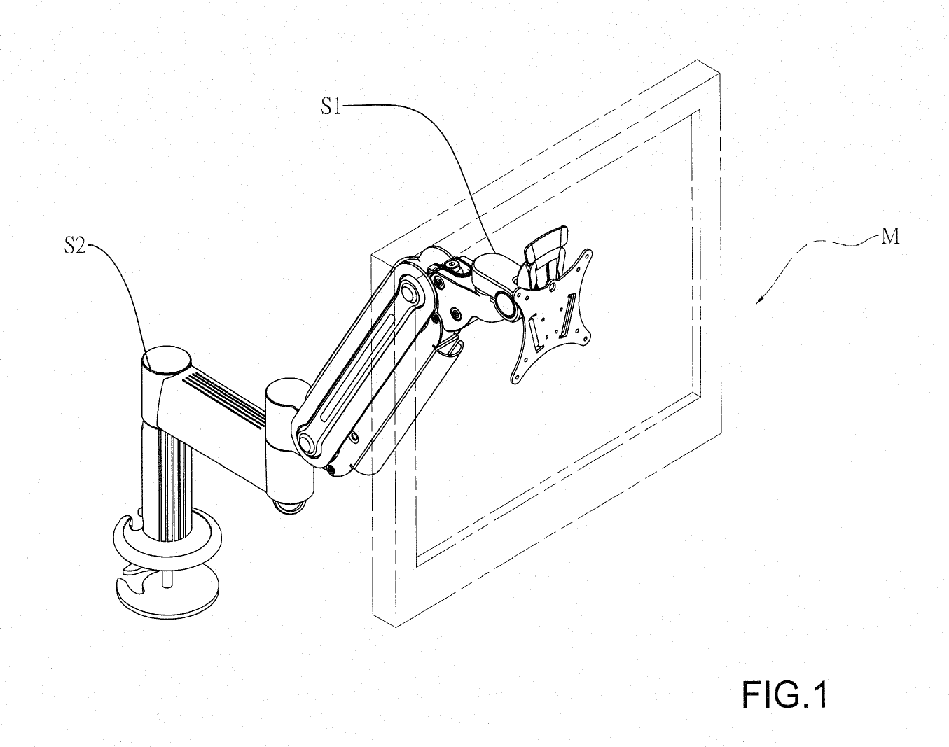

Referring to FIG. 1, the structure of the present invention is illustrated. In the present invention, a supporting frame of a suspending arm is combined to a supporting seat S2 and a screen supporting seat S2 so that the user can adjust an elevation and position of a screen.

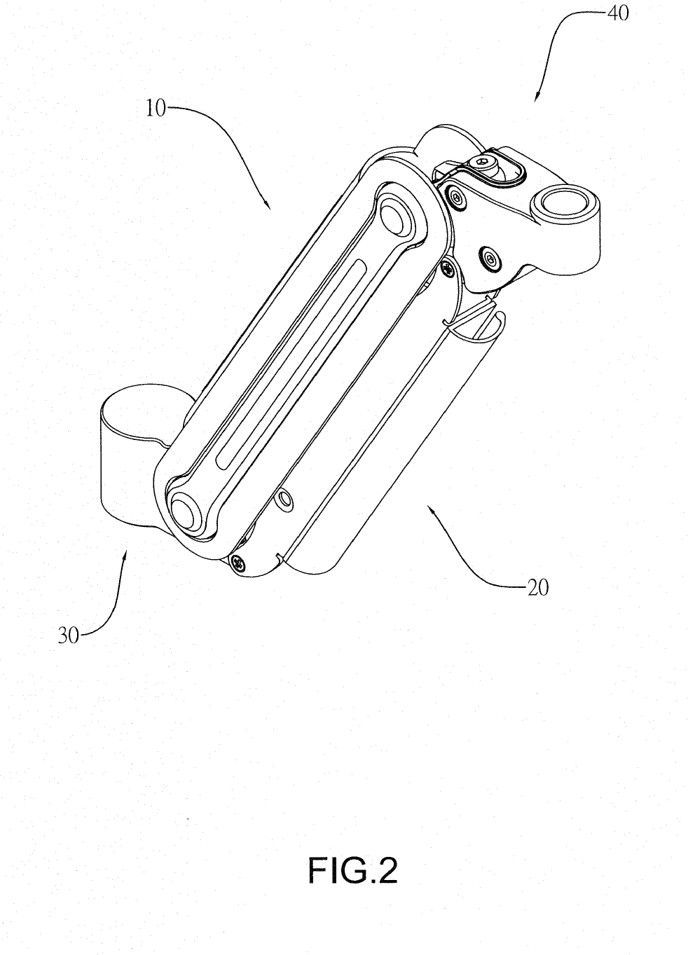

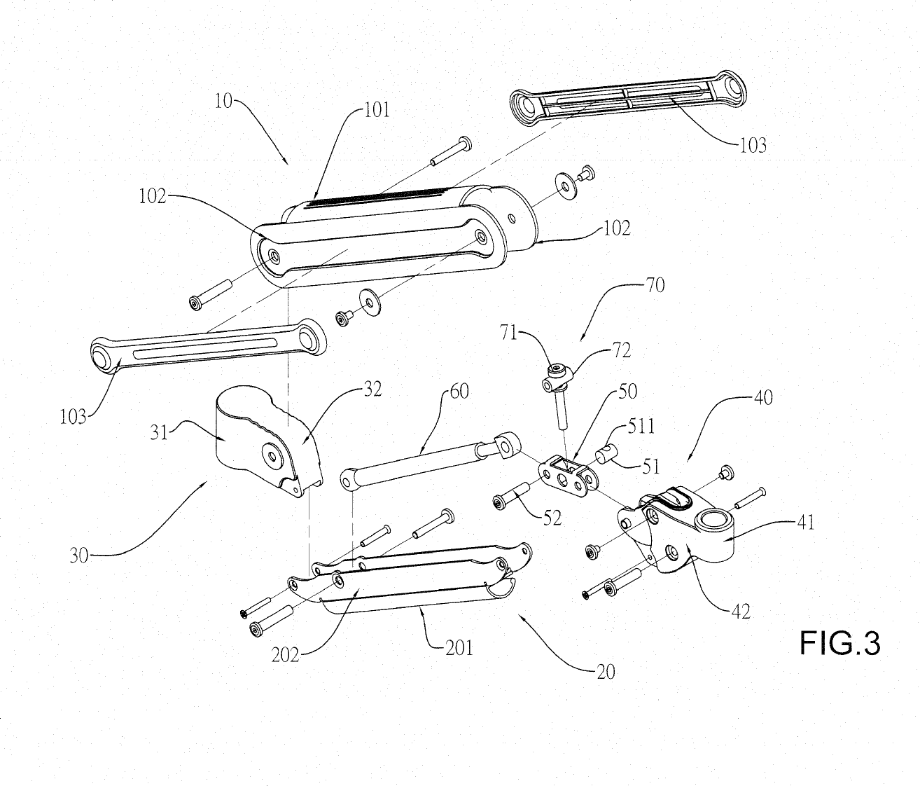

Referring to FIGS. 2 and 3 the elements of the present invention are illustrated. The present invention has the following elements.

An upper supporting arm 10 is included.

A lower supporting arm 20 is included.

A supporting seat joint 30 has a first adaptor unit 31 and a first pivot unit 32. The first pivot unit 32 is pivoted to the upper supporting arm 10 and lower supporting arm 20 so that the upper supporting arm 10 and lower supporting arm 20 are pivoted to the supporting seat joint 30.

A screen joint 40 includes a second adaptor unit 41 and a second pivot unit 42. The second pivot unit 42 is pivoted to the upper supporting arm 10 and lower supporting arm 20 so that the upper supporting arm 10 and lower supporting arm 20 is pivotally rotatable with respect to the screen joint 40. One end of the connecting block 50 is pivoted into the screen joint 40.

An air pressure bar 60 is included. One end of an air pressure bar 60 is pivoted to the lower supporting arm 20 and another end of air pressure bar 60 is pivoted to the connecting block 50.

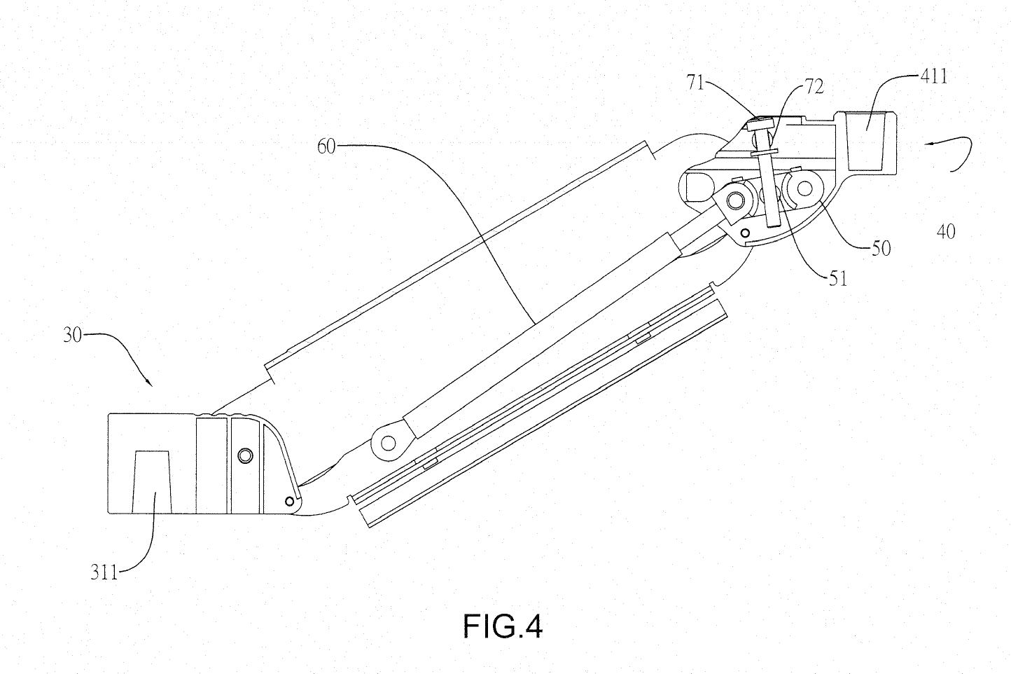

A fine adjusting unit 70 includes a screw 71 and a positioning block 72. The screw 71 passes through the positioning block 72 and is then screwed to the connecting block 50. The positioning block 72 is connected to the screen joint 40. When the screw 71 rotates, the connecting block 50 is pushed or pulled. By adjusting the screw 71, the relative positions of the positioning block 72 and the connecting block 50 are changed. The screw 71 is a manual adjust screw so that the user can operate it without needing any tool. By the fine adjusting unit 70 to adjust the position of the connecting block 50, a length of the air pressure bar 60 is adjustable so that the supporting force released from the air pressure bar 60 is changed without using any other locking way so that the orientation of the structure of the present invention is retained. Referring to FIG. 4, each of the supporting seat joint 30 and the screen joint 40 has a respective combining groove 311, 411, respectively.

Referring to FIG. 2, the upper supporting arm 10 includes a top sheet 101 and two lateral sheets 102. The lower supporting arm 20 includes a bottom sheet 201 and two lateral sheets 202. After assembly, they are used to mask the air pressure bar 60 and other elements therein so as to protect theses elements. Moreover, each of the two lateral sheets 102 is connected to a cover 103 for covering the pivotal holes of the upper supporting arm 10 to present a beautiful outlook.

With reference to FIGS. 3, 4 and 5, a shaft 52 serves to pivot the air pressure bar 60 and the connecting block 50 at the same point. Further, a threaded block 51 is installed in the connecting block 50. The threaded block 51 has a screw hole 511 for receiving the screw 71. When the screw 71 is rotated, the threaded block 51 will be driven to rotate. By the threaded block 51 to push the connecting block 50, the position of the connecting block 50 is changed. One end of the connecting block 50 is pivoted to the screen joint 40 and thus the connecting block 50 will rotate along a pivoted point. When the rotate angle of the connecting block 50 is changed, the length of the air pressure bar 60 pivoted thereto is also changed so as to adjust the supporting force.

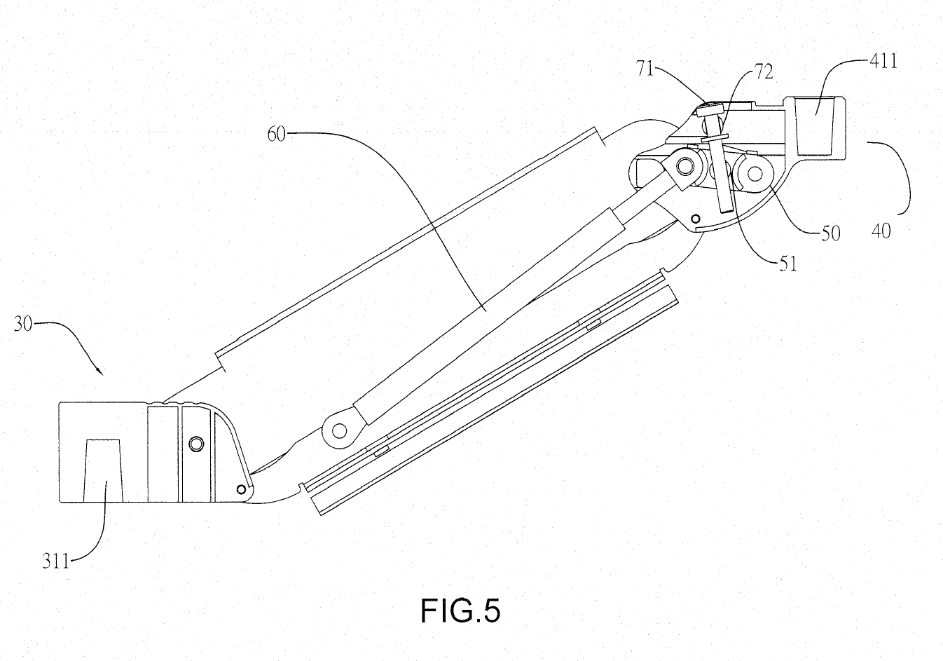

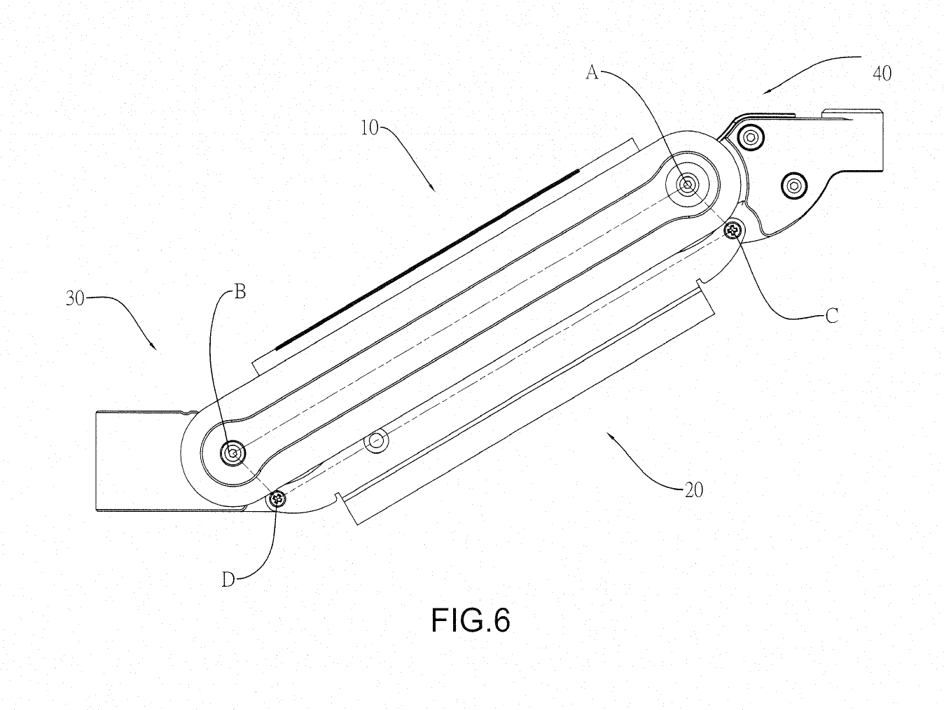

Referring to FIG. 5, a distance AB between the pivotal point A of the upper supporting arm 10 to the adjusting unit 144 and the pivotal point B of the supporting seat joint 30 and the upper supporting arm 10 is equal to a distance CD between the pivotal point C of the lower supporting arm 20 and the screen joint 40 and the pivotal point D of the lower supporting arm 20 and the supporting seat joint 30. Furthermore the distance AC is also equal to the distance BD so that the pivotal points A, B, C and D is formed as a parallelogram (as the dashed lines illustrated in the drawing). Thus if the orientation of the air pressure bar 60 is adjusted, the screen joint 40 is also adjusted.

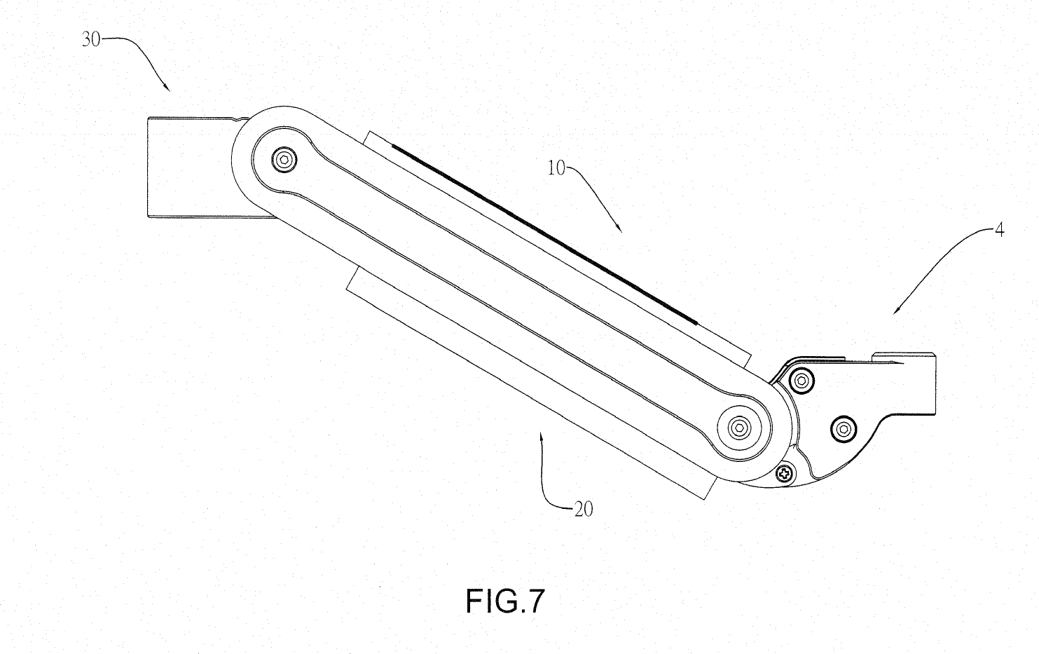

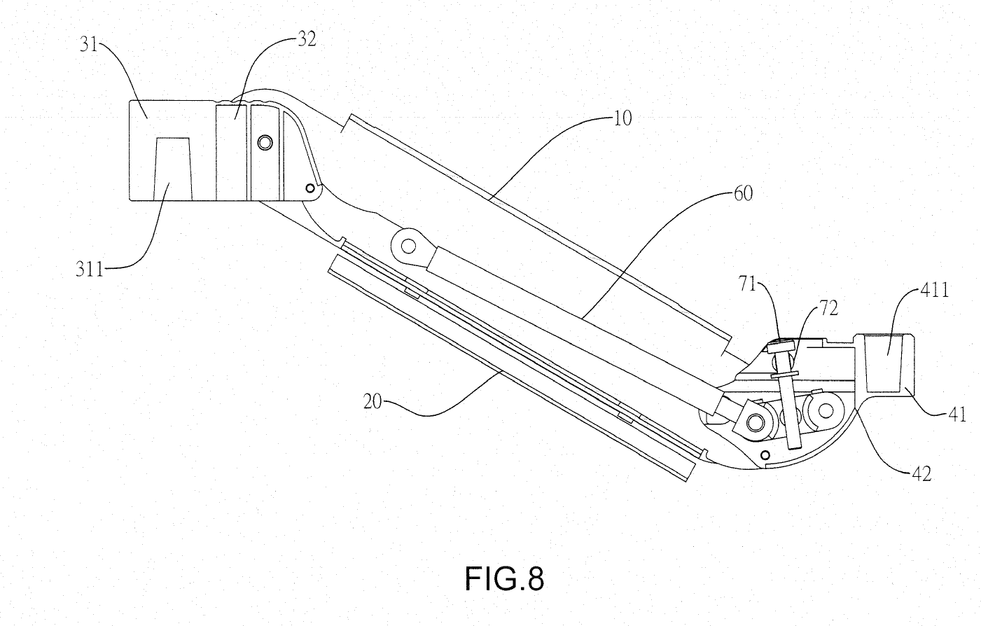

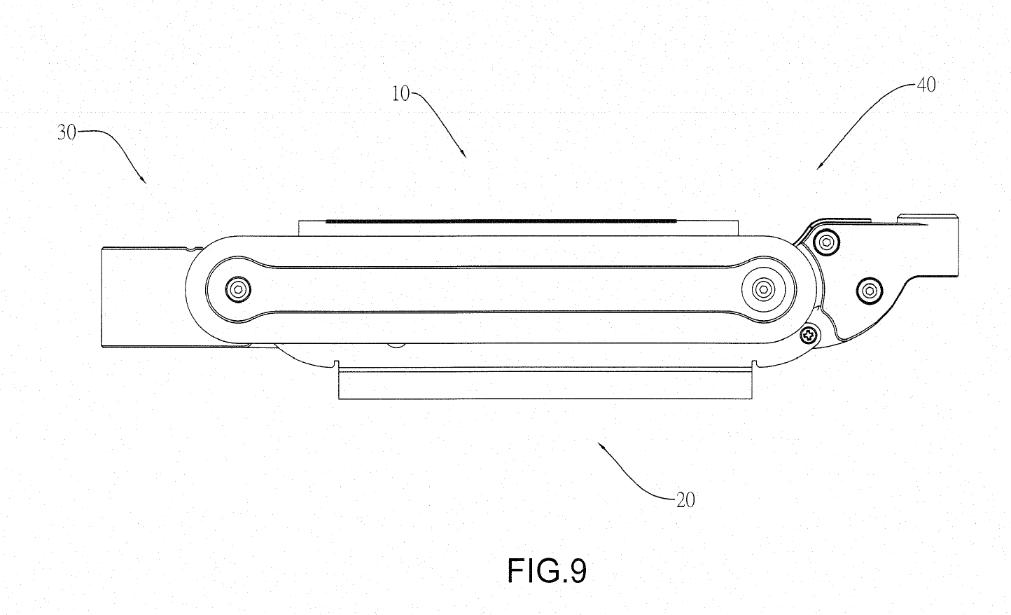

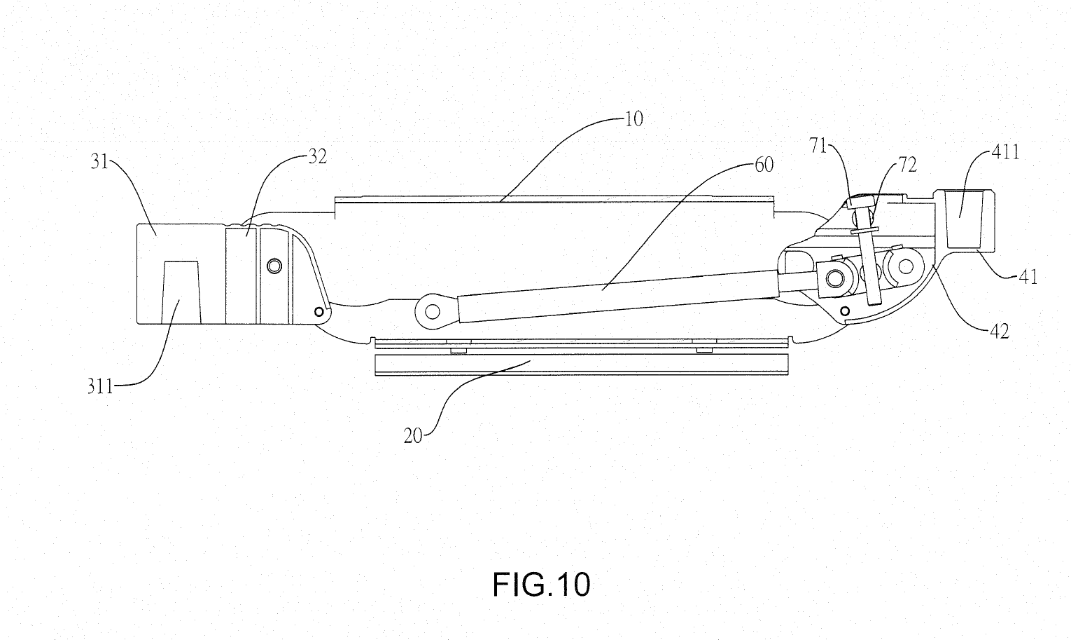

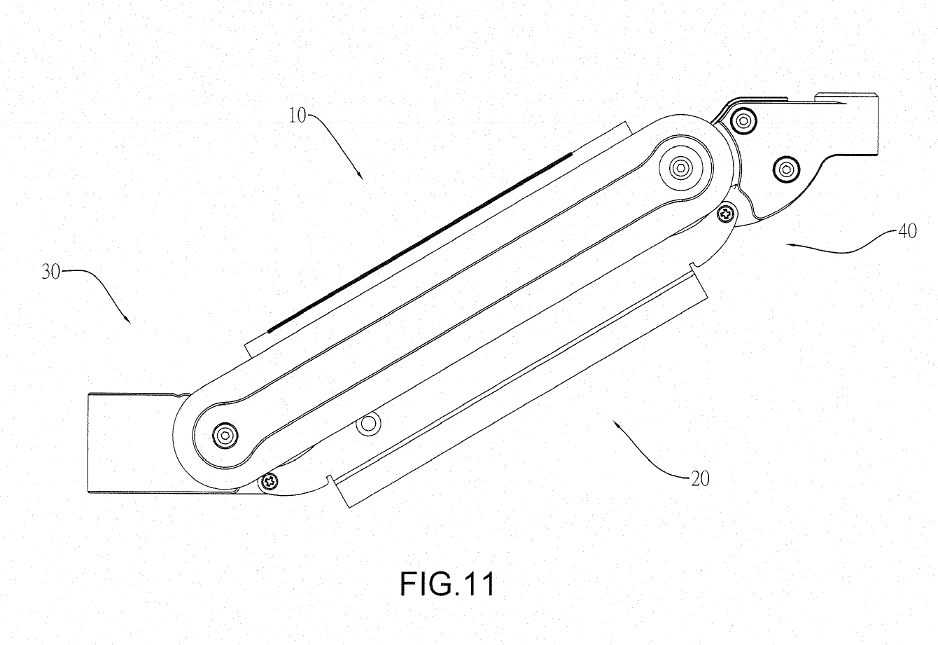

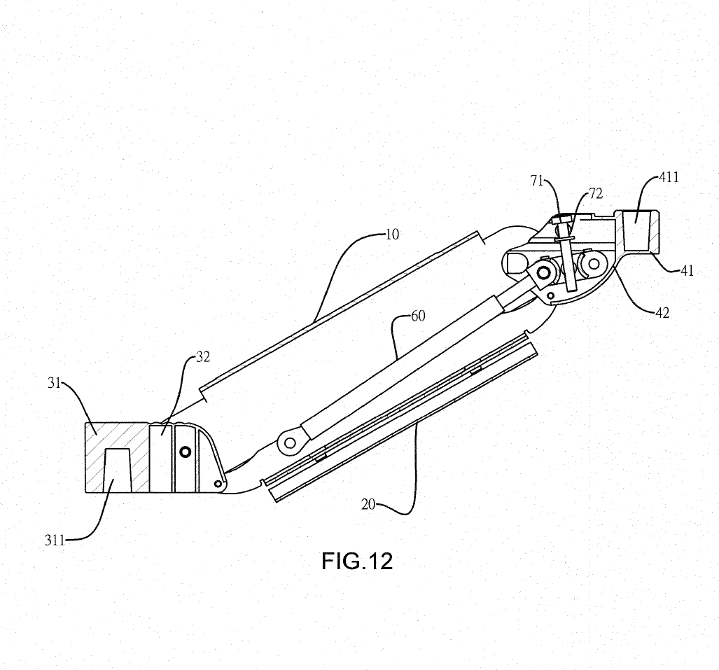

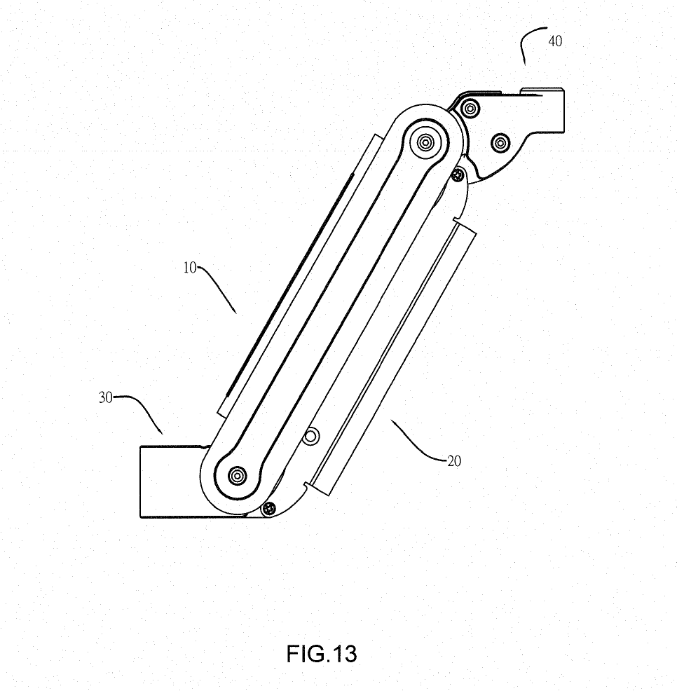

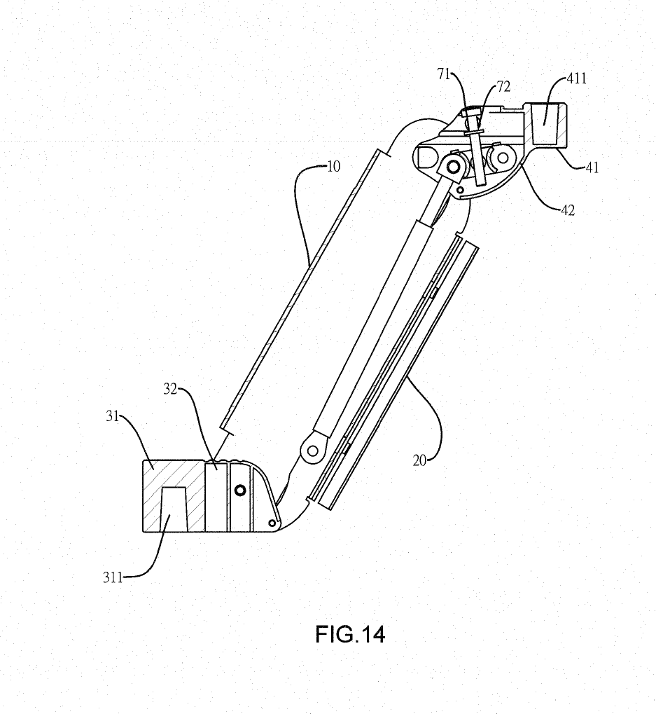

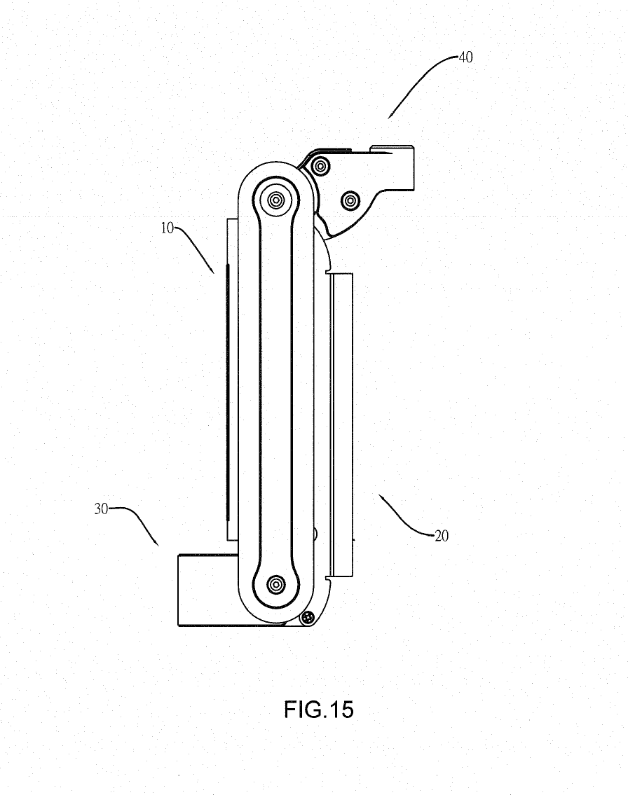

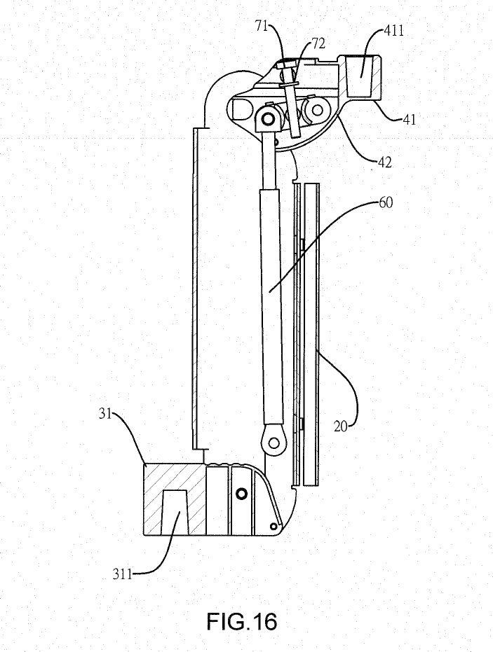

Referring to FIGS. 7 to 16, the use of the present invention is illustrated. It is illustrated that the pivotal points A, B, C and D are retained with a predetermined relation and thus the screen joint 40 is retained in a fixed direction. The length of the air pressure bar 60 is also changed so as to have different supporting force without any external force.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A suspending arm combined to a screen supporting frame; comprising:
an upper supporting arm;
a lower supporting arm;
a supporting seat joint having a first adaptor unit and a first pivot unit; the first pivot unit being pivoted to the upper supporting arm and the lower supporting arm;
a screen joint including a second adaptor unit and a second pivot unit; the second pivot unit being pivoted to the upper supporting arm and the lower supporting arm; one end of the connecting block is pivoted into the screen joint;
an air pressure; one end of an air pressure bar being pivoted to the lower supporting arm and another end of air pressure bar being pivoted to the connecting block;
a fine adjusting unit including a screw and a positioning block; the screw passing through the positioning block and being then screwed to the connecting block; the positioning block being connected to the screen joint; and
wherein by the fine adjusting unit to adjust the position of the connecting block, a length of the air pressure bar is adjustable so that the supporting force released from the air pressure bar is changed without using any other locking way so that the orientation of the suspending arm is retained.

2. The suspending arm combined to a screen supporting frame as claimed in claim 1, wherein a shaft serves to pivot the air pressure bar and the connecting block at the same point.

3. The suspending arm combined to a screen supporting frame as claimed in claim 2, wherein a threaded block is installed in the connecting block.

4. The suspending arm combined to a screen supporting frame as claimed in claim 2, wherein the upper supporting arm includes a top sheet and two lateral sheets and the lower supporting arm includes a bottom sheet and two lateral sheets.

5. The suspending arm combined to a screen supporting frame as claimed in claim 4, wherein each of the two lateral sheets is connected to a cover.

6. The suspending arm combined to a screen supporting frame as claimed in claim 1, wherein a distance AB between the pivotal point A of the upper supporting arm and the adjusting unit and the pivotal point B of the supporting seat joint and the upper supporting arm is equal to a distance CD between the pivotal point C of the lower supporting arm 20 and the screen joint and the pivotal point D of the lower supporting arm and the supporting seat joint; and the distance AC is also equal to the distance BD so that the pivotal points A, B, C and D is formed as a parallelogram.

7. The suspending arm combined to a screen supporting frame as claimed in claim 1, wherein the supporting seat joint has a respective combining groove.

8. The suspending arm combined to a screen supporting frame as claimed in claim 1, wherein the screen joint has a respective combining groove.

9. The suspending arm combined to a screen supporting frame as claimed in claim 1, wherein the screw is a manual adjustable screw.
